(19) United States
(12) Patent Application Publication
(10) Pub. No.: US 2013/0060644 A1
(43) Pub. Date: Mar. 7, 2013

(54) INTERACTION-BASED PRICING OF ELECTRONIC ADS

(71) Applicants: Franck Le Ouay, Palo Alto, CA (US); Romain Niccoli, Paris (FR)

(72) Inventors: Franck Le Ouay, Palo Alto, CA (US); Romain Niccoli, Paris (FR)

(73) Assignee: CRITEO S.A., Palo Alto, CA (US)

(21) Appl. No.: 13/225,251

(22) Filed: Sep. 2, 2011

(51) Int. Cl. G06Q 30/02

(52) U.S. Cl. 705/14.69

(57) ABSTRACT

Interaction-based pricing of electronic ads is disclosed. An indication is received of a first interaction by an individual with an advertiser at least in part via an electronic advertisement that has been displayed to the individual. The electronic advertisement provides two or more distinct interactions the individual could elect to have at least in part via the advertisement and each of the two or more distinct interactions has associated with it a corresponding interaction-specific value to the advertiser. The advertiser is charged, in response to the indication, an interaction-specific amount associated with the first interaction.

### BACKGROUND OF THE INVENTION

Online and other electronic advertising enables advertisers to reach consumers by displaying an electronic advertisement to them, for example on their computer; a phone or other mobile device; a television or movie screen; an electronic billboard; a radio spot; or via other electronic media. In the online context, ad exchanges and networks have been developed to enable advertisers to find and compete (e.g., bid) for available spaces in which to display their ads and to provide publishers a way to find ads to be displayed on the publishers' pages.

Various revenue and pricing metrics are used in online advertising. In one approach, an advertiser pays a negotiated and/or a bid “cost per thousand impressions” or “cost per mille” (CPM), or some other measure of the number of times an ad has been served, loaded, viewed by a unique user, etc. In a typically alternative approach, an advertiser pays a “cost per click” (CPC) or other action or performance (such as only when a user completes a purchase transaction).

### BRIEF DESCRIPTION OF THE DRAWINGS

Various embodiments of the invention are disclosed in the following detailed description and the accompanying drawings.

FIG. 1 is a block diagram illustrating an embodiment of an electronic advertising system and environment.

FIG. 2 is a flow diagram illustrating an embodiment of an electronic advertising process.

FIG. 3 is a flow diagram illustrating an embodiment of a process of electronic advertising.

FIG. 4 is a flow diagram illustrating an embodiment of a process to create and serve an electronic advertisement.

FIGS. 5A and 5B are block diagrams illustrating of electronic advertisements.

FIG. 6 is a flow diagram illustrating an embodiment of an electronic advertising process.

FIG. 7 is a flow diagram illustrating an embodiment of an electronic advertising process.

FIG. 8 is a flow diagram illustrating an embodiment of a process to identify advertising opportunities.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Interaction-based pricing of electronic advertising is disclosed. In various embodiments, an advertiser may be charged a different non-zero price depending on how a user interacts with an electronic ad of the advertiser. For example, an online or other electronic ad may include two or more interactive features, such as clickable or otherwise selectable links, and the advertiser may be charged a different amount determined at least in part by a user-selected manner in which the user interacts with the electronic advertisement. In some embodiments, an advertiser may submit for each of a plurality of possible types of interaction a corresponding interaction-specific bid amount. For example, in various embodiments advertisers may bid by category, product, or other distinguishing factor. Ads potentially embodying a plurality of selectable and/or otherwise interactive elements are displayed to a consumer or other user. The advertiser is charged in various embodiments a dynamically determined price that is based at least in part on an interaction of the user with the ad. For example, in the case of an online banner or other ad, the advertiser may be charged a first price if the user clicks a first selectable region of the ad (such as a button) or instead a second price if the user instead clicks a second selectable region of the ad.

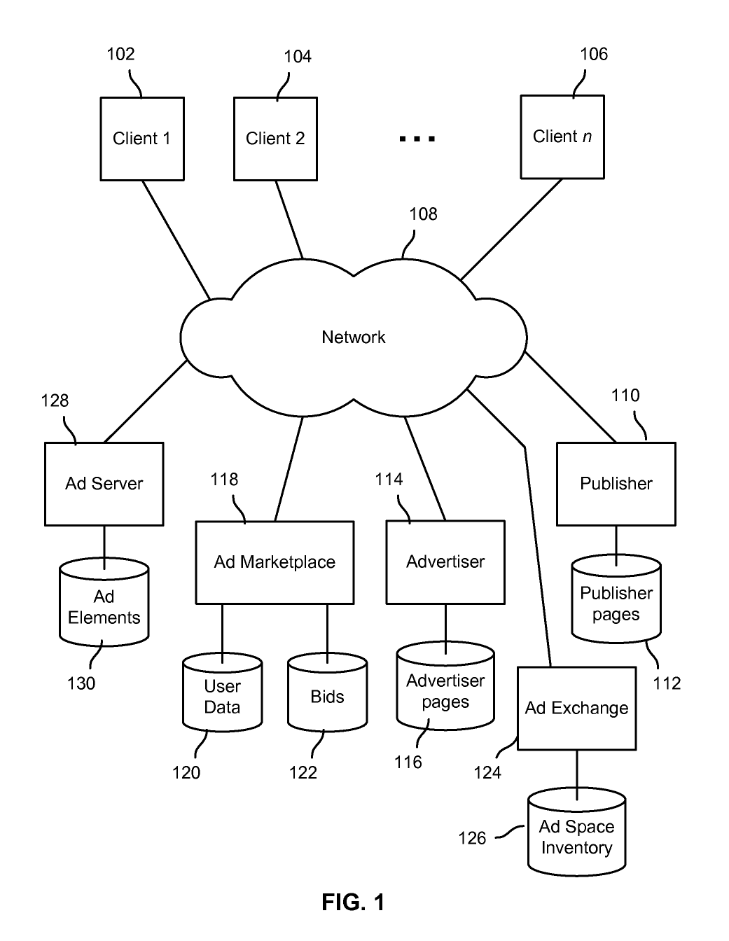

FIG. 1 is a block diagram illustrating an embodiment of an electronic advertising system and environment. In the example shown, a plurality of client systems, represented in FIG. 1 by clients 102, 104, and 106, are connected, for example and without limitation via wired, wireless, and/or other physical media, to a network 108, such as the Internet. Clients such as clients 102, 104, and 106 access publisher content, such as web pages, available from servers such as publisher 110, which serve publisher pages 112, for example in response to HTTP or other requests. Clients such as clients 102, 104, and 106 similarly can access online stores and/or other advertisers, represented in FIG. 1 by advertiser 114, by navigating advertiser web pages 116. A user of a client may interact with advertiser 114 to find and potentially purchase a specific product, for example. In the example shown, an online or other electronic advertising marketplace system 118 is configured to store in a data store 120 data reflecting interactions of specific users with a specific advertiser, such as advertiser 114. In various embodiments, user privacy is maintained by using a globally unique identifier, such as a random number, to track a user's interaction with an advertiser's site, for example, pages viewed, products placed in an online shopping cart but not purchased, etc., without storing personal identifying information about the user. In the example shown, the advertising marketplace 118 is configured to receive and store in a data store 122 bids from one or more advertisers. In various embodiments, advertising marketplace 118 is configured to enable advertisers to bid different amounts by category, product, or other attribute. If a consumer or other user interacts with the advertiser's ad in a manner associated with a particular category, product, or other attribute, the advertiser is charged a price that is based at least in part on the corresponding amount bid by the advertiser for an interaction associated with that category, product, or other attribute. For example, an advertiser may bid a lower amount for a click or other action and/or performance (such as actual purchase after click through) on a lower value and/or margin product than a similar user action with respect to a higher value and/or margin product.

In various embodiments, a specific advertising opportunity is acquired and an electronic ad is created dynamically and served. In the example shown in FIG. 1, for example, in some embodiments ad server 128 is configured to create and serve an ad created at runtime, for example while the individual to whom the ad is to be served is viewing or waiting to view a display page on which the ad is to be shown. In various embodiments, templates and other ad elements stored in ad element store 130 are used to create and serve an ad determined by advertising marketplace 118 to be served to a particular user, for example by acquiring an ad location on a publisher page being displayed and/or about to be displayed on a client system such as 102, 104, or 106. While ad server 128 and advertising marketplace 118 are shown as separate systems in the example shown in FIG. 1, in various embodiments they may be included in the same logical and/or physical system and/or their respective functions spread across a plurality of logical and/or physical systems and/or across a plurality of physical (e.g., geographic) locations.

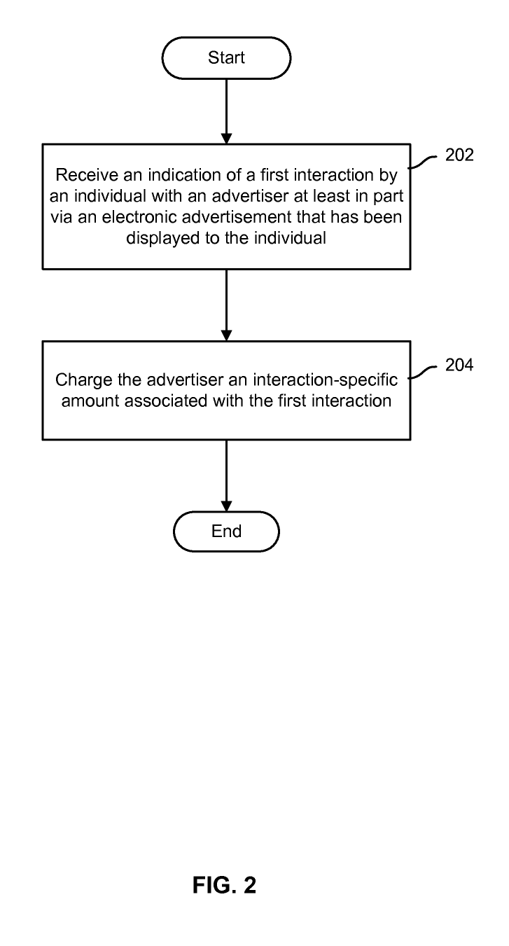

FIG. 2 is a flow diagram illustrating an embodiment of an electronic advertising process. In the example shown, an indication of a first interaction by an individual with an advertiser at least in part via an electronic advertisement that has been displayed to the individual is received (202). In various embodiments, the electronic advertisement provides two or more distinct interactions the individual could elect to have at least in part via the advertisement and each of the two or more distinct interactions has associated with it a corresponding interaction-specific value to the advertiser. The advertiser is charged an interaction-specific amount associated with the first interaction (204).

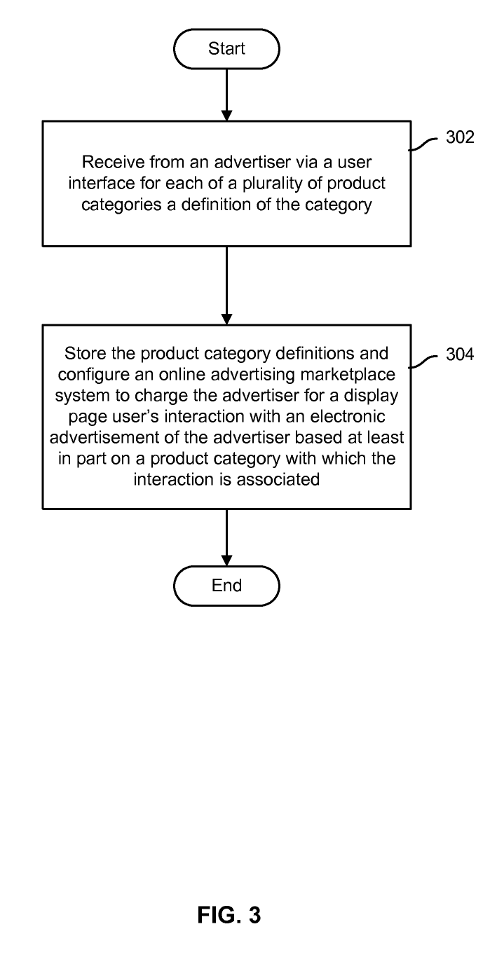

FIG. 3 is a flow diagram illustrating an embodiment of a process of electronic advertising. In the example shown, for each of a plurality of product categories a definition of the category is received from an advertiser via an advertiser user interface (302). The product category definitions are stored, and an online advertising marketplace system is configured to charge the advertiser for a display page user's interaction with an electronic advertisement of the advertiser based at least in part on a product category with which the interaction is associated (304).

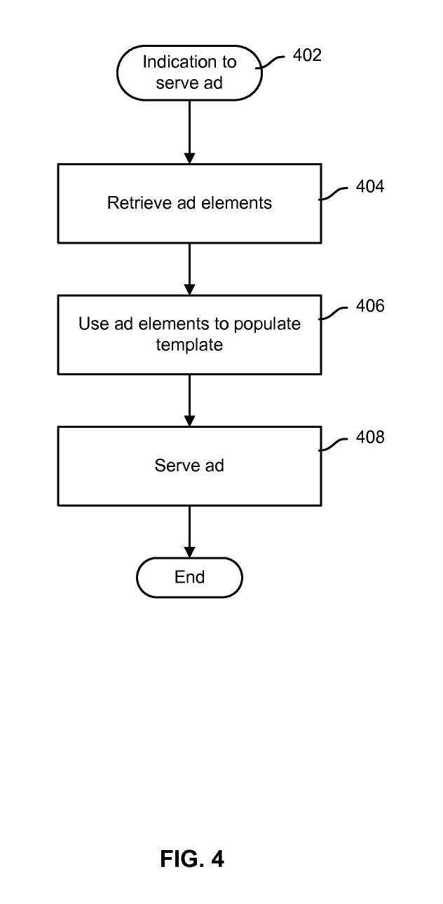

FIG. 4 is a flow diagram illustrating an embodiment of a process to create and serve an electronic advertisement. In the example shown, an indication to create and serve a specific ad comprising identified ad elements is received (402). The component ad elements are retrieved (404) and used to populate an ad template (406). The dynamically created ad is served to be displayed in a corresponding ad space that has been acquired (408).

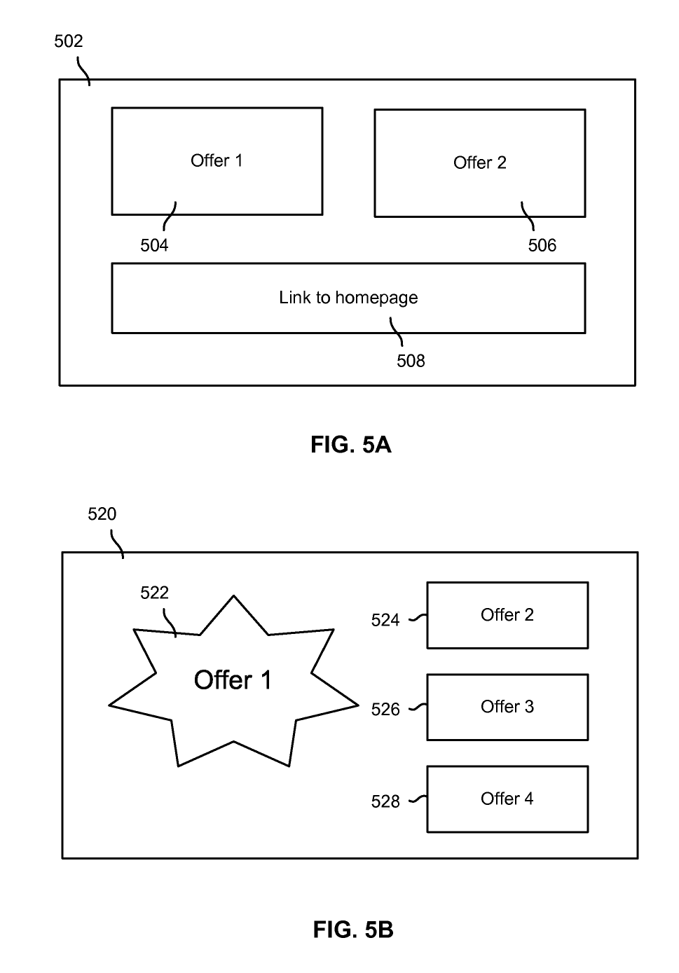

FIGS. 5A and 5B are block diagrams illustrating of electronic advertisements. In the example shown in FIG. 5A, electronic advertisement 502 includes three independently clickable or otherwise selectable areas, including a first specific offer area 504, a second specific offer area 506, and a generic offer area 508. For example, an offer or enticement to “buy” a first product A may be displayed and associated with first specific offer area 504, a second offer to “buy” a second product B may be displayed and associated with second specific offer area 506, and a generic invitation to return to the advertiser's online store may be shown in generic offer area 508. In various embodiments, selection by a viewing user of first specific offer area 504 may result in the user being redirected to a shopping cart page pre-populated with information to complete an online purchase of product A; selection of second specific offer area 506 may result in the user being redirected to a shopping cart page pre-populated with information to complete an online purchase of product B; and selection of generic offer area 508 may result in the user being redirected to the advertiser's homepage. Depending on which area is selected, and whether any other associated performance by the user is required, the advertiser would in various embodiments be charged an at least potentially different amount determined based at least in part on which selectable area the user viewing the ad selected or otherwise interacted with.

In the example shown in FIG. 5B, the electronic advertisement 520 includes a featured offer selectable area 522, for example to display an enticement to “buy” an item the user had placed in a shopping cart but not purchased at the advertiser's online store. The advertisement 520 also includes three independently selectable secondary offer areas 524, 526, and 528, each usable to display an ad element comprising a secondary offer, such as for complementary and/or substitute products for the product offered in the featured offer area 522.

As the examples in FIGS. 5A and 5B illustrate, ads comprising any number of independently selectable and at least partly independently priced ad elements, and any desired creative or other non-functional elements, may be used.

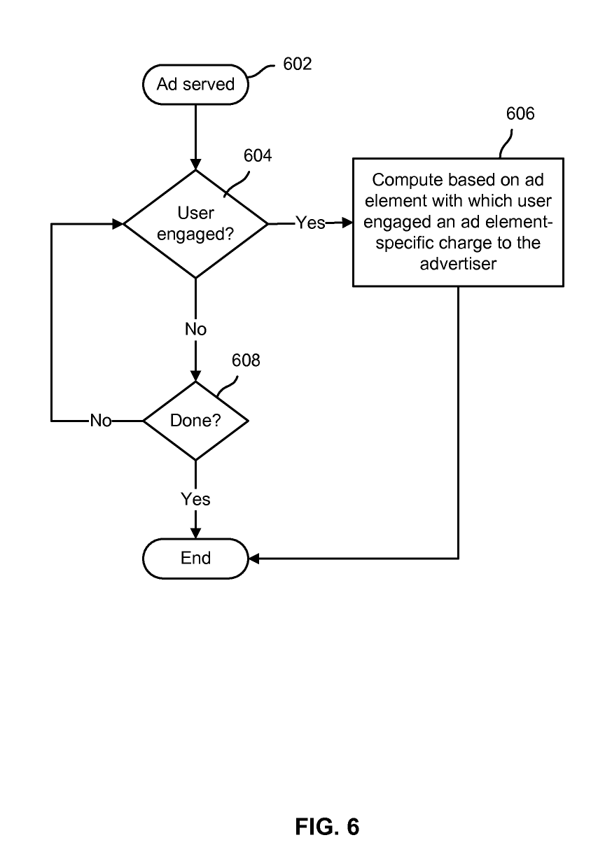

FIG. 6 is a flow diagram illustrating an embodiment of an electronic advertising process. In the example shown, once an ad has been served as described herein (602), if an indication of user engagement with the ad is received (604), for example the user clicks one of a plurality of selectable areas on the ad, then an amount to charge the advertiser is determined based at least in part on an ad element with which the user interaction (or other engagement and/or performance) is associated (606). For example, if the user selected the first of three selectable areas on the ad, then in some embodiments a bid or other amount associated with that area is used to determine the charge to the advertiser.

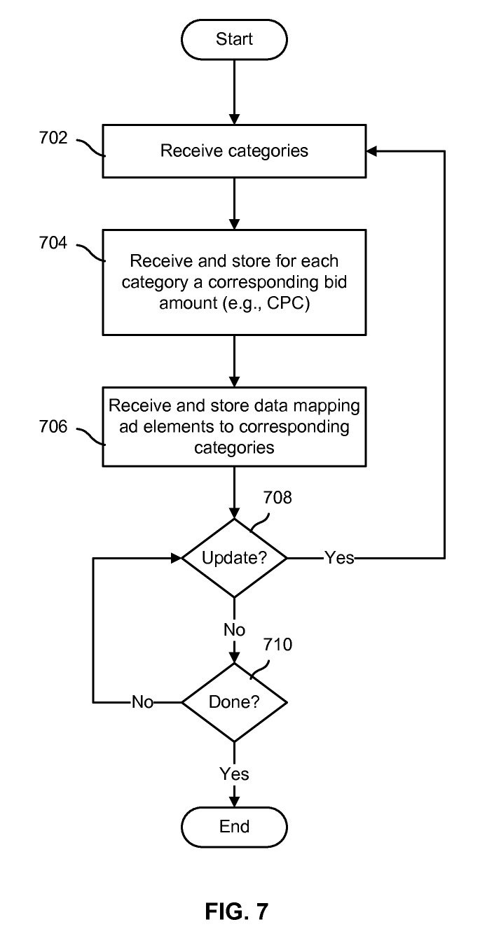

FIG. 7 is a flow diagram illustrating an embodiment of an electronic advertising process. In various embodiments, the process of FIG. 7 enables advertisers to define advertising campaigns and submit and/or update bids. In the example shown, categories defined and/or selected by the advertiser are received (702). Examples of categories include without limitation individual products; product types, groups, or other product categories; and any category defined by a user. In some embodiments, an online or other tool is provided to enable advertisers to select and/or define categories. For each category, a corresponding bid (for example, a cost-per-click) is received (704). The bid represents an amount the advertiser will pay to receive a corresponding performance (e.g., user click, view, completed purchase transaction, or other user action or performance) with respect to the category. For example, in the case of a category corresponding to a specific product or other item available for sale by the advertiser, in various embodiments the bid may represent an amount the advertiser will pay if a user clicks on a portion of an ad associated with that category, such as an offer to “buy” the product or in other embodiments an amount the advertiser will pay if the user completes a purchase transaction to buy the item from the advertiser. Data that associates previously stored ad elements (for example, clickable ad elements usable to populate a template, as described above) with corresponding categories is received and stored (706). In some embodiments, both ad elements and data about ad elements and their relationship to categories are determined at least in part by parsing and processing advertiser catalog feeds and/or other structured data that describes the advertiser's product or other offerings. In various embodiments item name, description, price, and other data and metadata are processed to determine categories and/or the relationship between categories and corresponding ad elements. In some embodiments, a tool or other interactive interface is provided to enable a human user to validate associations determined through automated processing and/or to define such associations manually and/or based on displayed data, such as by dragging a graphic representation of a product to a corresponding graphic that represents a category with which the product is desired to be associated. In the example shown, the categories, ad elements, ad element to category mappings, and category-specific bids may be updated at any time by an advertiser or their authorized agent (708). The process continues until done (710).

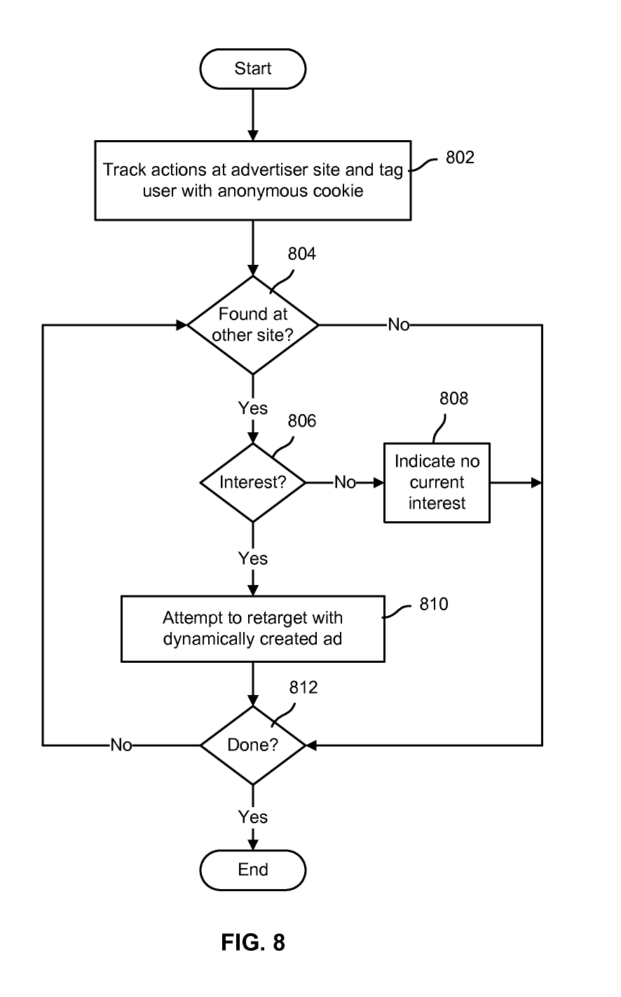

FIG. 8 is a flow diagram illustrating an embodiment of a process to identify advertising opportunities. In the example shown, a visitor to an advertiser's online store is tagged with an anonymous cookie (802). The cookie is used to track the user's actions at the advertiser's site. Cookie matching and/or other techniques are used to recognize the user when the user visits others sites (804). For example, a pixel tag or other data and/or code comprising or associated with a publisher web page the user visits may be used to determine that the publisher page viewer is the same user as a specific recent visitor to the advertiser's online store. If a recent visitor to the advertiser's store is found at another site at which an opportunity to display an ad to the user is or may be present (804), it is determined (for example by an advertising marketplace) whether the advertiser is or may be interested in providing an ad to be displayed to the user (806). For example, the advertising marketplace may use tracking data associated with the user's recent activity at the advertiser's site to determine whether ad exists that is relevant to the user's activities at the advertiser's site. While in the example shown in FIG. 8 cookie-based techniques are used, for example to track the user's recent activities at the advertiser's site, in other embodiments other techniques may be used to identify advertising opportunities of interest and/or to determine and/or generate an ad to serve. For example, in some embodiments, demographic data such as gender or age, or geographic data such a geographic location determined to be associated with the user, may be used to determine whether a particular advertising opportunity is of interest. Referring further to FIG. 8, if the advertiser is not interested (or if multiple advertisers were visited recently, if no advertiser is interested) (806), the advertising marketplace informs the publisher or other source offering the advertising opportunity that the advertising marketplace is not currently interested in providing ads for display to the user (808). If on the other hand at least one advertiser has defined criteria that indicate the advertiser does or may have an ad to display (806), then an attempt is made to acquire the ad opportunity and display a dynamically created ad to the user (810). The process continues until done (812).

While a number of embodiments described herein involve online advertising, techniques disclosed herein may be used in other electronic advertising contexts. For example, and without limitation, user behavior with respect to an advertiser, certain products or categories of products, or otherwise may be tracked based on user interactions via other media, such as cable or other interactive TV, satellite radio, mobile phone or other mobile applications and/or location-based technologies, etc. and/or manually captured and entered data based on other user interactions, such as point of sale transactions, sales cells, etc. Subsequently, an opportunity to display an electronic advertisement to the same user may be identified, such as by using mobile phone, onboard navigation, or other location-based technologies to recognize a user's location, presence in the vehicle, active listening to the radio or viewing the TV, passing a nearby electronic billboard while driving in a direction facing the billboard, etc., and if criteria indicate interest in displaying ads to the user electronic ads may be evaluated, selected, and displayed to the user as described herein. In various embodiments, as described above in the context of online ads the advertiser is charged an amount determined at least in part by user engagement or other performance by that specific user in response to the ad, including in some embodiments a different amount depending on different portions of the advertising content with which the user engages.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method of electronic advertising, comprising:
receiving an indication of a first interaction by an individual with an advertiser at least in part via an electronic advertisement that has been displayed to the individual, wherein the electronic advertisement provides two or more distinct interactions the individual could elect to have at least in part via the advertisement and each of the two or more distinct interactions has associated with it a corresponding interaction-specific value to the advertiser; and
charging the advertiser, in response to the indication, an interaction-specific amount associated with the first interaction.

2. The method of claim 1, wherein the interaction-specific amount associated with the first interaction is different than a corresponding interaction-specific amount associated with one or more other of the two or more distinct interactions provided by the electronic advertisement.

3. The method of claim 1, wherein the interaction-specific amount associated with the first interaction is determined at least in part by a category with which the first interaction is associated.

4. The method of claim 3, wherein the category comprises an advertiser-defined category.

5. The method of claim 4, further comprising receiving from an advertiser via an advertiser user interface a definition of the category and an input that associates the first interaction with the category.

6. The method of claim 3, wherein the category comprises a product category.

7. The method of claim 3, wherein the category reflects at least in part how far along in a purchase process the user has progressed in a prior interaction with the advertiser.

8. The method of claim 1, wherein the electronic advertising space comprises an ad display space on a display page.

9. The method of claim 1, wherein the advertiser comprises an online advertiser.

10. The method of claim 1, wherein one or more of the two or more distinct interactions provided by the electronic advertisement are determined at least in part based on a prior interaction of the individual with the advertiser.

11. The method of claim 1, wherein the interaction-specific amount associated with the first interaction is determined dynamically, at or near the time of the first interaction.

12. The method of claim 11, wherein the interaction-specific amount associated with the first interaction with respect to the individual is a first amount for a first instance of the first interaction by the individual and a second amount, less than the first amount, for a subsequent instance of the same interaction by the same individual.

13. The method of claim 1, wherein the first interaction comprises a click and the interaction-specific amount charged to the advertiser is expressed as a cost per click (CPC).

14. The method of claim 1, further comprising receiving from the advertiser a first bid indicating an amount the advertiser will pay to obtain a first of said two or more distinct interactions by a user such as the individual, and a second bid indicating an amount the advertiser will pay to obtain a second of said two or more distinct interactions by a user such as the individual.

15. The method of claim 1, wherein each of at least a subset of the two or more distinct is interactions comprises an offer with which the interaction is associated.

16. The method of claim 15, wherein the offer comprises an offer to purchase a product.

17. The method of claim 1, further comprising assembling the electronic advertisement dynamically while the individual interacts with a display page with which the advertising space is associated.

18. The method of claim 1, wherein each advertisement is unique to a particular individual, at a particular time, with respect to a particular advertising space.

19. An electronic advertising marketplace system, comprising:
a communication interface; and
a processor coupled to the communication interface and configured to:
receive via the communication interface an indication of a first interaction by an individual with an advertiser at least in part via an electronic advertisement that has been displayed to the individual, wherein the electronic advertisement provides two or more distinct interactions the individual could elect to have at least in part via the advertisement and each of the two or more distinct interactions has associated with it a corresponding interaction-specific value to the advertiser; and
charge the advertiser, in response to the indication, an interaction-specific amount associated with the first interaction.

20. The system of claim 19, wherein the interaction-specific amount associated with the first interaction is different than a corresponding interaction-specific amount associated with one or more other of the two or more distinct interactions provided by the electronic advertisement.

21. The system of claim 19, wherein the interaction-specific amount associated with the first interaction is determined at least in part by a category with which the first interaction is associated.

22. The system of claim 21, wherein the category comprises an advertiser-defined category.

23. The system of claim 22, wherein the processor is configured to receive from an advertiser via the communication interface a definition of the category and an input that associates the first interaction with the category.

24. The system of claim 19, wherein the processor is configured to determine the interaction-specific amount associated with the first interaction dynamically, at or near the time of the first interaction.

25. A computer program product for operating an electronic advertising marketplace, the computer program product being embodied in a tangible computer readable storage medium and comprising computer instructions for:
receiving an indication of a first interaction by an individual with an advertiser at least in part via an electronic advertisement that has been displayed to the individual, wherein the electronic advertisement provides two or more distinct interactions the individual could elect to have at least in part via the advertisement and each of the two or more distinct interactions has associated with it a corresponding interaction-specific value to the advertiser; and
charging the advertiser, in response to the indication, an interaction-specific amount associated with the first interaction.

26. A method of electronic advertising, comprising:
receiving an indication of an interaction by an individual with an advertiser at least in part via an electronic advertisement that has been displayed to the individual; and
charging the advertiser, in response to the indication, an interaction-specific amount associated with the interaction;
wherein the interaction comprises one of a plurality of distinct interactions that could be selected to be provided by the advertisement; and each of the distinct interactions has associated with it a corresponding interaction-specific value to the advertiser, the interaction-specific value of each distinct interaction being determined at least in part by a category with which that distinct interaction is associated.

27. The method of claim 26, wherein the category comprises an advertiser-defined category.

28. The method of claim 26, wherein the category comprises a product category.

29. The method of claim 26, wherein the category reflects at least in part how far along in a purchase process the user has progressed in a prior interaction with the advertiser.
